(19) United States
(12) Patent Application Publication
(10) Pub. No.: US 2025/0162917 A1
(43) Pub. Date: May 22, 2025

(54) ULTRAPURE WATER PRODUCTION SYSTEM AND METHOD FOR PRODUCING ULTRAPURE WATER

(71) Applicant: ORGANO CORPORATION, Tokyo (JP)

(72) Inventors: Takafumi HOSHINO, Nagano (JP); Tadashi SATO, Tokyo (JP)

(73) Assignee: ORGANO CORPORATION, Tokyo (JP)

(21) Appl. No.: 18/841,090

(22) PCT Filed: Jan. 23, 2023
(86) PCT No.: PCT/JP2023/001880

§ 371 Date: Aug. 23, 2024

(30) Foreign Application Priority Data
Mar. 1, 2022 (JP) 2022-030638

(51) Int. Cl. C02F 9/00; C02F 1/28; C02F 1/32; C02F 1/42; C02F 1/72; C02F 101/10; C02F 103/04

(52) U.S. Cl. CPC C02F 9/00; C02F 1/285; C02F 1/32; C02F 1/42; C02F 1/72; C02F 2101/108; C02F 2103/04

(57) ABSTRACT

An ultrapure water production system for producing ultrapure water with reduced boron concentration includes: a primary pure water tank that communicates with the outside air and stores primary pure water; and a subsystem that is connected to the primary pure water tank to produce ultrapure water. Unused ultrapure water of the ultrapure water that has been produced in the subsystem is circulated to the primary pure water tank. The subsystem includes: a boron removal device filled with a boron-selective resin and a non-regenerative ion exchange device arranged downstream of the boron removal device.

### TECHNICAL FIELD

The present invention relates to an ultrapure water production system that can be installed in a clean room, for example, and a method for producing ultrapure water.

### BACKGROUND ART

As systems for producing ultrapure water easily in laboratories of research institutes or the like, there are pure water production apparatuses described in, for example, Patent Literatures 1 and 2. The pure water production apparatus described in Patent Literature 1 is equipped with: a primary pure water system that produces primary pure water from supplied water; a primary pure water tank that stores primary pure water; a subsystem that is supplied with primary pure water from the primary pure water tank to produce ultrapure water; and a water dispenser that is supplied with ultrapure water from the subsystem and used for dispensing ultrapure water. The subsystem is equipped with: an ultraviolet oxidization device to which primary pure water is supplied from the primary pure water tank; and a non-regenerative ion exchange device installed at the subsequent stage of the ultraviolet oxidization device. In the subsystem, ultrapure water that is not supplied to the water dispenser is circulated to the primary pure water tank, whereby circulation purification are performed. The pure water production apparatus disclosed in Patent Literature 1 is configured such that the primary pure water system and the subsystem are housed in the same enclosure and the primary pure water tank can be placed adjacent to this enclosure, so that it can be placed on a laboratory table or the like as a table-top device. In the pure water production apparatus disclosed in Patent Literature 2, the piping through which pure water circulates in the subsystem is extended to the water dispenser, and the water dispenser is also incorporated in the pure water circulation system in the subsystem. The combination of a primary pure water system and a subsystem in the production of ultrapure water is a well-known technique, and the subsystem is also called a secondary pure water system.

When ultrapure water is used in fields related to semiconductor device manufacturing, it is required to reduce concentration of boron in the ultrapure water as much as possible. Patent Literature 3 discloses that, in order to obtain ultrapure water with a high degree of boron removal over a long period of time, an ion exchange device filled with a mixture of a boron-adsorbent resin and a strongly-basic anion exchange resin is installed in the primary pure water system of an ultrapure water production system. Similarly, in order to obtain ultrapure water with reduced boron concentration while minimizing the impact of elution of TOC (Total Organic Carbon) components from the boron-selective ion exchange resin on the subsystem of the ultrapure water production system, Patent Literature 4 discloses that an ion exchange device in which a boron-selective ion exchange resin is placed on the supply side of the water to be treated and an ion exchange resin other than the boron-selective ion exchange resin is filled in the discharge side is installed in the primary pure water system of an ultrapure water production system.

Generally, manufacturing of semiconductor devices and research related to semiconductor devices are conducted in clean rooms. In clean rooms, HEPA filters (High Efficiency Particulate Air High Filters) and ULPA filters (Ultra Low Penetration Air Filters) are used to filter the air in the room at all times to remove airborne particles, such as dust and dirt, in the air, thereby maintaining a clean environment. A HEPA filter is an air filter with a particle collection rate of 99.97% or more for particles having a diameter of 0.3 μm at rated airflow. An ULPA filter is an air filter with a particle collection rate of 99.9995% or more for particles having a diameter of 0.15 μm at rated airflow. HEPA and ULPA filters often use glass filters as filter media. Non-patent Literature 1 states that the boron concentration in clean room air is higher than the boron concentration in outdoor air, and that the boron is presumably derived from ULPA filters. As an example, Non-Patent Literature 1 states that boron concentration in the air inside a clean room was 130 ng/m³ when boron concentration in the outdoor air was 17 ng/m³.

### CITATION LIST

### Patent Literature

Patent Literature 1: JP 2018-202293 A
Patent Literature 2: JP 2020-6295 A
Patent Literature 3: JP 2016-47496 A
Patent Literature 4: JP 2018-86619 A

### Non-Patent Literature

Non-Patent Literature 1: “Evaluation Methods for Trace Impurities in Clean Room Air,” Technical News, TN045 [online], Sumika Chemical Analysis Service, Ltd., [Retrieved on Jan. 20, 2022], Internet <URL: https://www.scas.co.jp/technical-informations/technical-news/pdf/tn045.pdf>

### SUMMARY OF INVENTION

### Technical Problem

When ultrapure water is produced by placing equipment such as that shown in Patent Literature 1 or 2 in a clean room, the boron concentration in the resulting ultrapure water may not be sufficiently reduced.

The object of the present invention is to provide an ultrapure water production system and a production method capable of producing ultrapure water with reduced boron concentration.

### Solution to Problem

The present inventors investigated the phenomenon of high boron concentration in ultrapure water produced in clean rooms and made the following findings. That is, the liquid level of the primary pure water tank in the subsystem of the ultrapure water production system varies depending on the amount of ultrapure water actually used at the point of use and the amount of primary pure water supplied to the tank. In large ultrapure water production systems, nitrogen (N₂) gas purging is performed, so the space above the liquid surface in the primary pure water tank is filled with nitrogen gas. However, in a small ultrapure water production system such as a table-top system, the primary pure water tank communicates with outside air and air from outside the tank enters the primary pure water tank through the air vent filter as the liquid level in the primary pure water tank fluctuates. If the small ultrapure water production system is installed in a clean room, boron components in the air in the clean room will enter the primary pure water tank and dissolve in the pure water in the primary pure water tank, causing an increase in boron concentration in the ultrapure water obtained by the subsystem. As ultrapure water circulates in the subsystem, the concentration of boron in the ultrapure water increases further over time. Since boron is brought into the subsystem at the primary pure water tank, boron removal treatment in the primary pure water system does not reduce the concentration of boron in the ultrapure water.

Based on the above findings, the present inventors have completed the present invention. Thus, the ultrapure water production system according to the present invention is characterized that, in an ultrapure water production system including a primary pure water tank which communicates with outside air and stores primary pure water, and a subsystem which is connected to the primary pure water tank to produce ultrapure water, unused ultrapure water of ultrapure water that has been produced in the subsystem being circulated to the primary pure water tank, the subsystem includes: a boron removal device filled with a boron-selective resin; and a non-regenerative ion exchange device arranged downstream of the boron removal device. The ultrapure water production method according to the present invention produces ultrapure water by installing the ultrapure water production system according to the present invention in a clean room.

According to the present invention, ultrapure water with reduced boron concentration can be produced in a clean room or the like.

### BRIEF DESCRIPTION OF DRAWINGS

FIG. 1 is a flow sheet showing an ultrapure water production system according to an embodiment of the present invention.

### DESCRIPTION OF EMBODIMENTS

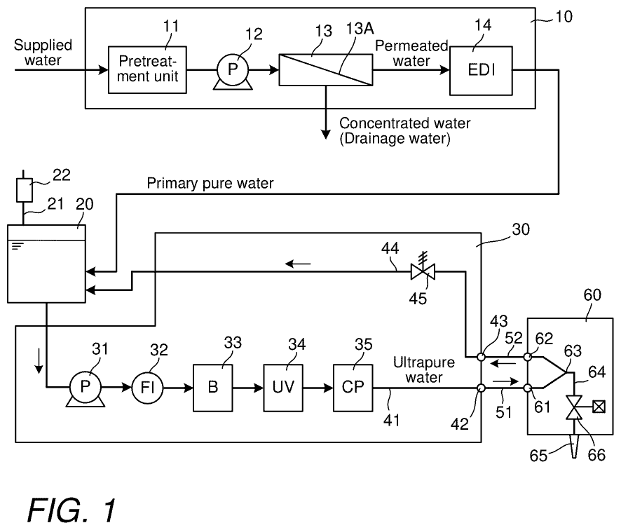

Next, embodiments of the present invention will be described with reference to the drawings. FIG. 1 shows an ultrapure water production system according to an embodiment of the present invention. This ultrapure water production system is a table-top system, for example, suitable for use in clean rooms. A clean room in this context is “a room that is classified according to number concentration of airborne particles, and that is designed, constructed and operated to control the inflow, generation and persistence of particles,” as defined in JIS (Japanese Industrial Standard) B9920-1; 2019. A clean room in which the ultrapure water production system according to the present embodiment is suitably used is, for example, a clean room that belongs to Class 1 to Class 8 in the air cleanliness classes specified in ISO 14644-1 standard.

The ultrapure water production system shown in the FIGURE is broadly divided into: primary pure water system 10 supplied with supplied water such as tap water to produce primary pure water; primary pure water tank 20 storing primary pure water produced by primary pure water system 10; and subsystem 30 connected to the primary pure water tank to produce ultrapure water. The ultrapure water produced by subsystem 30 is supplied to water dispenser 60, which is used to dispense ultrapure water.

The primary pure water system is equipped with: pretreatment unit 11, which includes an activated carbon device, filter, etc. and performs pretreatment of the supplied water; pump (P) 12 feeding the supplied water which has been treated in pretreatment unit 11; reverse osmosis membrane device 13, which is installed on the secondary side of pump 12 and equipped with reverse osmosis membrane 13A; and electrodeionization (EDI) device 14, which is supplied with permeated water from reverse osmosis membrane device 13 and performs deionization treatment on the permeated water. The treated water obtained by performing the deionization treatment in electrodeionization device 14 is primary pure water, which is then supplied to primary pure water tank 20 and stored in primary pure water tank 20. Concentrated water discharged from reverse osmosis membrane system 13 is discharged outside as drainage water.

Primary pure water tank 20 is fitted with communicating tube 21 that connects the space above the liquid surface in the tank to the outside air so that the pressure at the liquid surface inside the tank is at atmospheric pressure. The outside air here refers to the air outside primary pure water tank 20, and if primary pure water tank 20 is located in a clean room, then it refers to the air inside the clean room and not the outdoor atmosphere. Air vent filter 22 is provided in communicating tube 21 to prevent particles and other substances in the outside air from entering primary pure water tank 20. Air vent filter 22, for example, is configured by combining non-woven polypropylene fabric for dust control, activated carbon to absorb and remove volatile organic substances, and soda lime to absorb and remove carbon dioxide. Boron component, which is more prevalent in clean room air than in outdoor air, is not removed by air vent filter 22 of this common configuration. Ionic components other than carbonic acid are not removed by air vent filter 22 as well.

Subsystem 30 further purifies the primary pure water supplied from primary pure water tank 20 to produce ultrapure water. Subsystem 30 is configured to produce higher purity ultrapure water by circulating back, to primary pure water tank 20, the ultrapure water that is no longer used at the point of use among the ultrapure water produced. In primary pure water tank 20, which communicates with the outside air as described above, it is inevitable that boron components in the outside air will be mixed into the pure water in the tank. Therefore, in the ultrapure water production system according to the present embodiment, to obtain ultrapure water from which boron has been sufficiently removed, subsystem 30 is equipped with boron removal device 33 which is filled with boron-selective resin. Since ionic components may be brought into the system through air vent filter 22 in primary pure water tank 20, subsystem 30 is also equipped with non-regenerative ion exchange device (CP) 35, also called a cartridge polisher.

The boron-selective resin filled in boron removal device 33 is a chelating resin having a boron-selective polyhydric alcohol group as a functional group instead of an ion exchange group in the anion exchange resin, and selectively adsorbs and removes boron components. A polyhydric alcohol group with boron selectivity is, for example, an N-methylglucamine group. The boron-selective resins include, for example, ORLITE® X-U653J from Organo Corporation, AMBERSEP IRA743 from Organo Corporation, and DIAION® CRB03 from Mitsubishi Chemical Corporation. It is preferable to use boron-selective resins with low elution of TOC components. Specifically, when pure water is passed through the boron-selective resin at a space velocity (SV) of 50 to 200 h⁻¹, it is preferable to use a boron-selective resin with a TOC concentration increase of less than 1 ppb after passage compared to before passage. Boron components may be removed by a generic strongly-basic anion exchange resin other than the boron-selective resin. However, since boron exists in water in the form of boric acid, which is an extremely weak acid, when a general strongly-basic anion exchange resin is used to remove boron components, there is a risk that the strongly-basic anion exchange resin may break prematurely and leak the boron components into the treated water.

The boron-selective resin elutes a large amount of TOC components especially in the early stages of water flow, and elutes a small amount of metal components. It is also known that in boron-selective resins, the presence of carbonic acid reduces the boron removal rate. Since the general subsystem for ultrapure water production is equipped with an ultraviolet oxidation device that decomposes and removes TOC components through ultraviolet oxidation treatment and a non-regenerative ion exchange device that is installed at the subsequent stage of the ultraviolet oxidation device to adsorb and remove metallic components and carbonic acid components generated by the ultraviolet oxidation device, it is preferable to install, in subsystem 30 according to the present embodiment, ultraviolet oxidation device 34 downstream of boron removal device 33, and non-regenerative ion exchange device 35 downstream of ultraviolet oxidation device 34.

Therefore, in this embodiment, subsystem 30 includes: pump (P) 31 connected to the outlet of primary pure water tank 20 to feed primary pure water stored in primary pure water tank 20; flowmeter (FI) 32 connected to the secondary side, or outlet, of pump 31; boron removal device (B) 33 to which the primary pure water is supplied via flowmeter 32; ultraviolet oxidation device (UV) 34 connected to the outlet of boron removal device 33; and non-regenerative ion exchange device 35 (CP) connected to the outlet of ultraviolet oxidation device 34. Ultrapure water flows out of the outlet of non-regenerative ion exchange device 35. In the present embodiment, since the piping for circulation purification is provided extending from subsystem 30 to water dispenser 60, ultrapure water flowing out of non-regenerative ion exchanger 35 is sent to circulation outlet 42 of subsystem 30 via supply piping 41. Subsystem 30 is equipped with circulation inlet 43 that accepts ultrapure water returned from water dispenser 60, and ultrapure water returned from water dispenser 60 is circulated to primary pure water tank 20 via circulation piping 44 connected to circulation inlet 43. Circulation piping 44 is equipped with relief valve 45.

Next, water dispenser 60 will be described. Water dispenser 60 is positioned, on a laboratory table or the like, at a location that is easily accessible to a user so that the user can easily collect ultrapure water in a beaker or other container. Therefore, water dispenser 60 may be located some distance away from subsystem 30. Water dispenser 60 includes: inlet 61 for accepting ultrapure water and outlet 62 for returning unused ultrapure water to subsystem 30. Inlet 61 is connected to circulation outlet 42 of subsystem 30 by piping 51 and outlet 62 is connected to circulation inlet 43 by piping 52. Inlet 61 and outlet 62 are connected at connection point 63 by piping inside water dispenser 60. Piping 64 extends from this connection point 63, and, at the end of piping 64, provided is nozzle 65 that discharges ultrapure water. Piping 64 is equipped with solenoid valve 66 to control the discharge of ultrapure water from nozzle 65.

When pump 31 is operated in subsystem 30, primary pure water in primary pure water tank 30 passes through boron removal device 33, ultraviolet oxidation device 34, and non-regenerative ion exchange device 35 in sequence to remove boron, TOC, and ion components from the primary pure water. This produces ultrapure water. Ultrapure water is supplied from circulation outlet 42 to water dispenser 60, returns to circulation inlet 43 of subsystem 30 through connection point 63 in water dispenser 60, and circulates through circulation piping 44 to primary pure water tank 20. The pressure of ultrapure water in water dispenser 60 is kept constant by providing relief valve 45 in circulation piping 44. When solenoid valve 66 is opened in this state, ultrapure water flows from connection point 63 toward nozzle 65 via piping 64, and ultrapure water is discharged from nozzle 65. Thus, the user can operate solenoid valve 66 to collect ultrapure water from which boron has been sufficiently removed.

### EXAMPLES

The following examples and comparative examples will illustrate the present invention in more detail.

### Example 1

The ultrapure water production system shown in FIG. 1, excluding primary pure water system 10, was assembled and installed in a clean room that meets Class 6 (i.e., Class 1000) standard of ISO 14644-1. In this clean room, HEPA filters are used to remove airborne particles. As the boron-selective resin filled in boron removal device 33, ORLITE® X-U653J from Organo Corporation was used, and non-regenerative ion exchange device 35 filled with ion exchange resin ESP-2 from Organo Corporation was used. As air vent filter 22 provided at primary pure water tank 20, one made of non-woven polypropylene fabric, activated carbon, and soda lime was used.

Subsystem 30 was operated by supplying ultrapure water with controlled boron concentration to primary pure water tank 20, and ultrapure water was continuously circulated in subsystem 30. As a result, the boron concentration in the outlet water of non-regenerative ion exchange device 35 was 0.1 ppt at one month after the start of operation, and 0.1 ppt at three months after the start of operation.

### Comparative Example 1

An apparatus identical to that in Example 1 was assembled except that it was not equipped with boron removal device 33, and this apparatus was operated in the same manner as in Example 1. As a result, the boron concentration in the outlet water of non-regenerative ion exchanger 35 was 0.3 ppt at one month after the start of operation, and 1.3 ppt at three months after the start of operation.

From the above, it was found that the ultrapure water production system based on the present invention can produce ultrapure water from which boron has been sufficiently removed, even when ultrapure water is produced in a clean room for a long period of time.

### REFERENCE SIGNS LIST

10 Primary pure water system,
11 Pretreatment unit,
13 Reverse osmosis membrane device,
13A Reverse osmosis membrane,
14 Electrodeionization device (EDI),
20 Primary pure water tank,
21 Communicating tube,
22 Air vent filter,
30 Subsystem,
33 Boron removal device (B),
34 Ultraviolet oxidation device (UV),
35 Non-regenerative ion exchange device (CP),
41 Supply piping,
44 Circulation piping.
45 Relief valve,
60 Water dispenser,
65 Nozzle, and
66 Solenoid valve.

1. An ultrapure water production system comprising:
a primary pure water tank which communicates with outside air and stores primary pure water; and
a subsystem which is connected to the primary pure water tank to produce ultrapure water, wherein
unused ultrapure water of ultrapure water that has been produced in the subsystem is circulated to the primary pure water tank, and
the subsystem comprises:
a boron removal device filled with a boron-selective resin; and
a non-regenerative ion exchange device arranged downstream of the boron removal device.

2. The ultrapure water production system according to claim 1, wherein the primary pure water tank communicates with the outside air via an air vent filter.

3. The ultrapure water production system according to claim 2, wherein the air vent filter is a filter that allows boron component in the outside air to pass through.

4. The ultrapure water production system according to claim 1, wherein an ultraviolet oxidation device is provided in the subsystem at a position downstream of the boron removal device and upstream of the non-regenerative ion exchange device.

5. The ultrapure water production system according to claim 1, further comprising a primary pure water system which produces primary pure water from supplied water, wherein primary pure water produced by the primary pure water system is supplied to the primary pure water tank.

6. A method for producing ultrapure water, wherein the ultrapure water production system according to claim 1 is installed in a clean room to produce ultrapure water.

7. The ultrapure water production system according to claim 2, wherein an ultraviolet oxidation device is provided in the subsystem at a position downstream of the boron removal device and upstream of the non-regenerative ion exchange device.

8. The ultrapure water production system according to claim 2, further comprising a primary pure water system which produces primary pure water from supplied water, wherein primary pure water produced by the primary pure water system is supplied to the primary pure water tank.

9. A method for producing ultrapure water, comprising:
installing the ultrapure water production system according to claim 1 in a clean room; and
operating the ultrapure water production system to produce ultrapure water in the clean room.
